(19) United States
(12) Patent Application Publication
(10) Pub. No.: US 2024/0148062 A1
(43) Pub. Date: May 9, 2024

(54) ELECTRONIC CIGARETTE ATOMIZATION CORE AND ELECTRONIC CIGARETTE

(71) Applicant: BYD PRECISION MANUFACTURE CO., LTD., Shenzhen (CN)

(72) Inventors: Hu ZHOU, Shenzhen (CN); Guirong YUE, Shenzhen (CN); Chaonan CHEN, Shenzhen (CN)

(21) Appl. No.: 18/399,725

(22) Filed: Dec. 29, 2023

Related U.S. Application Data
(63) Continuation of application No. PCT/CN2021/129900, filed on Nov. 10, 2021.

(30) Foreign Application Priority Data
Aug. 19, 2021 (CN) 202110964599.0

(51) Int. Cl. A24F 40/46; A24F 40/10; A24F 40/42; A24F 40/44; A24F 40/485; H05B 3/06

(52) U.S. Cl. CPC A24F 40/46; A24F 40/10; A24F 40/42; A24F 40/44; A24F 40/485; H05B 3/06; H05B 2203/004; H05B 2203/021

(57) ABSTRACT

An electronic cigarette atomization core and an electronic cigarette. The electronic cigarette atomization core includes a porous body and a heating body, the porous body includes a liquid absorbing end and an atomization end, the atomization end has an end surface facing away from the liquid absorbing end, and the heating body is arranged on the end surface. An atomization surface includes a first atomization region, the first atomization region is located on the end surface, the first atomization region is a region in which a temperature can reach a predetermined atomization temperature range by means of heating of the heating body, and a ratio of an area of the first atomization region to an area of the end surface ranges from 0.05 to 0.90.

### CROSS-REFERENCE TO RELATED APPLICATIONS

This application is a continuation of International Application No. PCT/CN2021/129900, filed on Nov. 10, 2021, which claims priority to Chinese Patent Application No. 202110964599.0, entitled “ELECTRONIC CIGARETTE ATOMIZATION CORE AND ELECTRONIC CIGARETTE” and filed on Aug. 19, 2021. The entire content of the above-mentioned application is incorporated in the present disclosure by reference.

### FIELD

The present disclosure belongs to the technical field of electronic cigarette atomization assemblies, and specifically, to an electronic cigarette atomization core and an electronic cigarette.

### BACKGROUND

An atomization core is an important component in an electronic atomization device and mainly includes a porous body and a heating body arranged on a surface of the porous body, where the porous body is in communication with a liquid storage cavity configured to store atomization liquid and may transfer the atomization liquid to the heating body, and the atomization liquid is atomized after being heated by the heating body.

However, heating bodies of existing ceramic atomization cores on the market are directly obtained by printing an electronic slurry on the porous body and then performing processing such as baking under a high temperature, electrode connection, and wiring on the electronic slurry. Although an area of an atomization surface of the existing porous body is large, temperature distribution is non-uniform when the heating body generates heat, and consequently, an effective heating area of the atomization core is small. In addition, a volume of the porous body is large. As a result, a heat loss of the heating body is great, and the use efficiency of an electronic cigarette is reduced.

### SUMMARY

An objective of embodiments of the present disclosure is to provide new technical solutions of an electronic cigarette atomization core and an electronic cigarette.

According to a first aspect of the present disclosure, an electronic cigarette atomization core is provided. The electronic cigarette atomization core includes:
a porous body, where the porous body includes a liquid absorbing end and an atomization end, and the atomization end includes an end surface facing away from the liquid absorbing end; and
a heating body, where the heating body is arranged on the end surface to form an atomization surface on the atomization end.

The atomization surface includes a first atomization region, the first atomization region is located on the end surface, the first atomization region is a region in which a temperature can reach a predetermined atomization temperature range by means of heating of the heating body, and a ratio of an area of the first atomization region to an area of the end surface ranges from 0.05 to 0.90.

Optionally, the ratio of the area of the first atomization region to the area of the end surface ranges from 0.25 to 0.75.

Optionally, the predetermined atomization temperature range is from 150° C. to 300° C.

Optionally, the atomization surface includes a second atomization region, the second atomization region is a region in which a temperature can reach the predetermined atomization temperature range by means of heating of the heating body, the second atomization region is at least a part of a side surface of the atomization end, and the side surface is adjacent to the end surface.

Optionally, a ratio of an area of the second atomization region to an area of the side surface ranges from 0.05 to 0.90.

Optionally, the electronic cigarette atomization core further includes a patch board, and the patch board is connected to two ends of the heating body.

A ratio of an area of the patch board to the area of the end surface ranges from 0.02 to 0.25.

Optionally, the heating body is arranged on the end surface in a shape of a square wave.

Optionally, the end surface is in a shape of an ellipse, the heating body is arranged in a length direction of the end surface, a first interval is formed between an edge of one end of the end surface and a corresponding end portion of the heating body, and a second interval is formed between an edge of a side of the end surface and a corresponding side of the heating body.

The first interval ranges from 0.05 mm to 4.0 mm, and the second interval ranges from 0.05 mm to 4.0 mm.

Optionally, the first interval ranges from 0.05 mm to 2.0 mm, and/or the second interval ranges from 0.05 mm to 2.0 mm.

Optionally, at least one section of an edge of the end surface is in a shape of a step.

Optionally, the heating body is arranged on the end surface in a shape of a wave.

Optionally, the end surface is in a shape of an ellipse, and the heating body is arranged in a length direction of the end surface.

Optionally, the end surface includes a first end surface and a second end surface that are perpendicular to each other, a length of the first end surface is greater than a length of the second end surface, and the heating body is arranged in a length direction of the first end surface.

Optionally, the heating body is arranged on the end surface in a shape of zigzag.

Optionally, the end surface is in a shape of an ellipse, and the heating body is arranged in a length direction of the end surface.

Optionally, the end surface includes a first end surface and a second end surface that are perpendicular to each other, a length of the first end surface is greater than a length of the second end surface, and the heating body is arranged in a length direction of the first end surface.

According to an embodiment of the present disclosure, an electronic cigarette is provided, and the electronic cigarette includes the electronic cigarette atomization core described in the present disclosure.

According to an embodiment of the present disclosure, the electronic cigarette includes the electronic cigarette atomization core of the present disclosure, a housing, a liquid storage cavity arranged in the housing, a first seal element, and a lower cover. The housing includes an opening end, the housing is provided with an air outlet channel, the lower cover covers the opening end of the housing to form a chamber, the lower cover has an air inlet hole, the first seal element is sleeved on the porous body, the first seal element at least covers a part of an outer peripheral surface of the porous body and an edge of the liquid absorbing end, the first seal element abuts against an inner wall of the housing, the electronic cigarette atomization core is arranged in the chamber, a space between the atomization end of the porous body and the lower cover forms an atomization chamber, and the atomization chamber is in communication with the air outlet channel and the air inlet hole, respectively.

According to an embodiment of the present disclosure, the electronic cigarette includes the electronic cigarette atomization core of the present disclosure, a housing, a liquid storage cavity arranged in the housing, a first seal element, and a lower cover. The housing includes an opening end, the housing is provided with an air outlet channel, the lower cover covers the opening end of the housing, the lower cover has an air inlet hole, the first seal element is sleeved on the porous body, and the first seal element at least covers a part of an outer peripheral surface of the porous body and an edge of the liquid absorbing end.

The electronic cigarette further includes an upper support and a second seal element. The upper support cooperates with and is connected to the lower cover to form a cavity, and the electronic cigarette atomization core is located in the cavity. The upper support has a liquid guide hole, and the liquid absorbing end of the porous body is in communication with the liquid storage cavity through the liquid guide hole. The second seal element is sleeved on a periphery of the upper support, an outer edge of the second seal element abuts against an inner wall of the housing to encircle and form the liquid storage cavity, the second seal element has a first communication hole communicating the liquid storage cavity with the liquid guide hole, and the second seal element has a second communication hole communicating the air outlet channel with the atomization chamber.

According to an embodiment of the present disclosure, the electronic cigarette includes the electronic cigarette atomization core of the present disclosure, a housing, a liquid storage cavity arranged in the housing, a first seal element, and a lower cover. The housing includes an opening end, the housing is provided with an air outlet channel, the lower cover covers the opening end of the housing, the lower cover has an air inlet hole, and the first seal element is sleeved on a periphery of the electronic cigarette atomization core. The electronic cigarette further includes an upper support, a second seal element, and a lower support. The upper support cooperates with the lower support to form an accommodating cavity, the electronic cigarette atomization core is arranged in the accommodating cavity, the upper support has a liquid guide hole, and the liquid absorbing end of the porous body is in communication with the liquid storage cavity through the liquid guide hole. An atomization chamber is formed between the atomization surface and the lower support, the lower support has a vent hole in communication with the air inlet hole, the second seal element is sleeved on a periphery of the upper support, an outer edge of the second seal element abuts against an inner wall of the housing to encircle and form the liquid storage cavity, the second seal element has a first communication hole communicating the liquid storage cavity with the liquid guide hole, and the second seal element has a second communication hole communicating the air outlet channel with an air outlet hole. The electronic cigarette further includes a third seal element. The third seal element is arranged surrounding a periphery of the lower cover, and an outer edge of the third seal element abuts against the inner wall of the housing.

According to an embodiment of the present disclosure, a conductive nail runs through the lower cover, and the conductive nail is electrically connected to the heating body.

A technical effect of the embodiments of the present disclosure is as follows:

An embodiment of the present disclosure provides an electronic cigarette atomization core, and the electronic cigarette atomization core includes a porous body and a heating body. The heating body of the electronic cigarette atomization core is arranged on the end surface, so that an atomization surface is formed on an atomization end. The atomization surface includes a first atomization region, the first atomization region is located on the end surface, and a ratio of an area of the first atomization region to an area of the end surface ranges from 0.05 to 0.90. The first atomization region is a region in which a temperature can reach a predetermined atomization temperature range by means of heating of the heating body. That is, e-liquid flowing to the first atomization region may be effectively atomized, so that the atomization efficiency of the electronic cigarette atomization core is improved while flexible arrangement of the heating body is ensured.

Through detailed description of exemplary embodiments of the present disclosure with following reference to the accompanying drawings, other features and advantages of the present disclosure will become clear.

### BRIEF DESCRIPTION OF THE DRAWINGS

The accompanying drawings incorporated in the specification as a part of the specification show embodiments of the present disclosure, and together with description thereof are used to explain the principle of the present disclosure.

FIG. 1 is a schematic diagram of an electronic cigarette atomization core according to an embodiment of the present disclosure;

FIG. 2 is a schematic diagram of a first variation of an electronic cigarette atomization core according to an embodiment of the present disclosure;

FIG. 3 is a schematic diagram of a second variation of an electronic cigarette atomization core according to an embodiment of the present disclosure;

FIG. 4 is a schematic diagram of a third variation of an electronic cigarette atomization core according to an embodiment of the present disclosure;

FIG. 5 is a schematic diagram of another electronic cigarette atomization core according to an embodiment of the present disclosure:

FIG. 6 is a schematic diagram of a first variation of another electronic cigarette atomization core according to an embodiment of the present disclosure;

FIG. 7 is a schematic diagram of a second variation of another electronic cigarette atomization core according to an embodiment of the present disclosure;

FIG. 8 is a schematic diagram of a third variation of another electronic cigarette atomization core according to an embodiment of the present disclosure;

FIG. 9 is a schematic diagram of still another electronic cigarette atomization core according to an embodiment of the present disclosure;

FIG. 10 is a schematic diagram of a first variation of still another electronic cigarette atomization core according to an embodiment of the present disclosure;

FIG. 11 is a schematic diagram of a second variation of still another electronic cigarette atomization core according to an embodiment of the present disclosure;

FIG. 12 is a schematic diagram of a third variation of still another electronic cigarette atomization core according to an embodiment of the present disclosure;

FIG. 13 is an exploded view of an electronic cigarette according to an embodiment of the present disclosure; and

FIG. 14 is a cross-sectional view of an electronic cigarette according to an embodiment of the present disclosure.

In the accompanying drawings:
1—Porous body; 3—Heating body; 4—Patch board;
100—Electronic cigarette atomization core; 101—Housing; 1011—Air outlet channel; 102—liquid storage cavity; 103—Upper support; 1031—Air outlet hole; 1032—Liquid guide hole; 104—Lower support; 105—Lower cover; 1051—Air inlet hole; 106—Atomization chamber; 107—Second seal element; 1071—First communication hole; 1072—Second communication hole; 108—First seal element; 109—Third seal element; and 1010—Liquid absorbing element.

### DETAILED DESCRIPTION

Various exemplary embodiments of the present disclosure are described below in detail with reference to the accompanying drawings. It should be noted that, unless otherwise specifically specified, arrangement, numeric expressions, and values of components and steps described in the embodiments are not intended to limit the scope of the present disclosure.

The following description of at least one exemplary embodiment is merely illustrative and should not be understood as any limitation on the present disclosure and application or use thereof.

Technologies, methods, and devices that are known to a person of ordinary skill in the art are not discussed in detail. However, in proper circumstances, the technologies, methods, and devices should be considered as a part of the specification.

In all examples that are shown and discussed in the specification, any specific value should be construed as exemplary rather than limitative. Therefore, other examples of the exemplary embodiment may have different values.

It should be noted that: similar reference numerals or letters in the accompanying drawings indicate similar items. Therefore, once an item is defined in one accompanying drawing, the item does not need to be further discussed in the subsequent accompanying drawings.

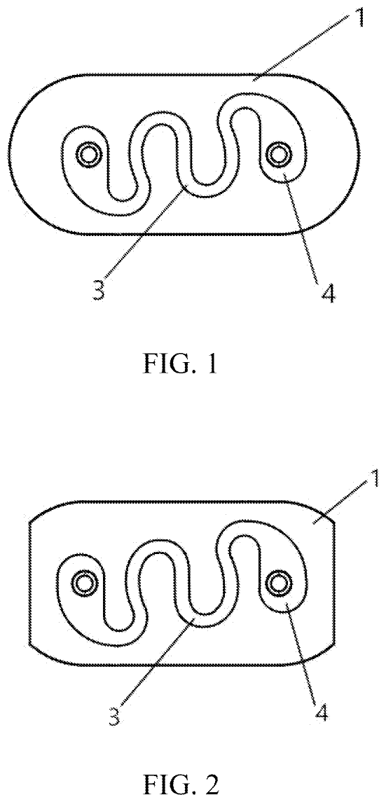

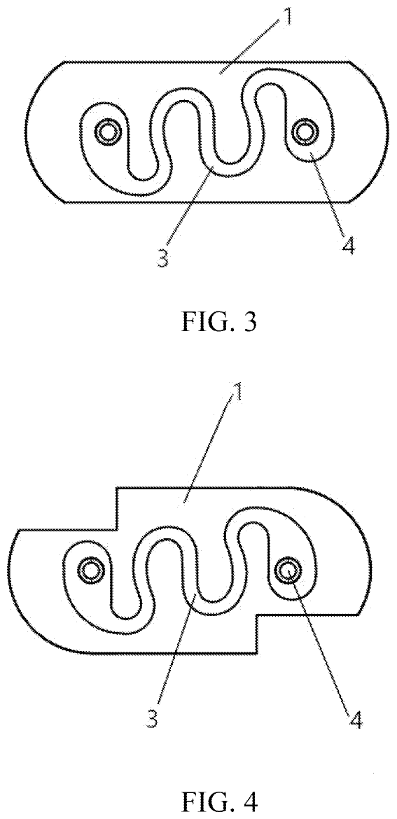

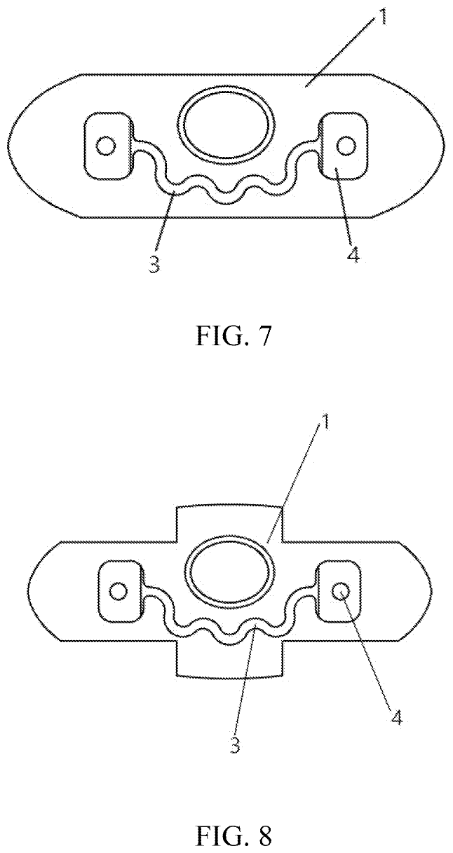

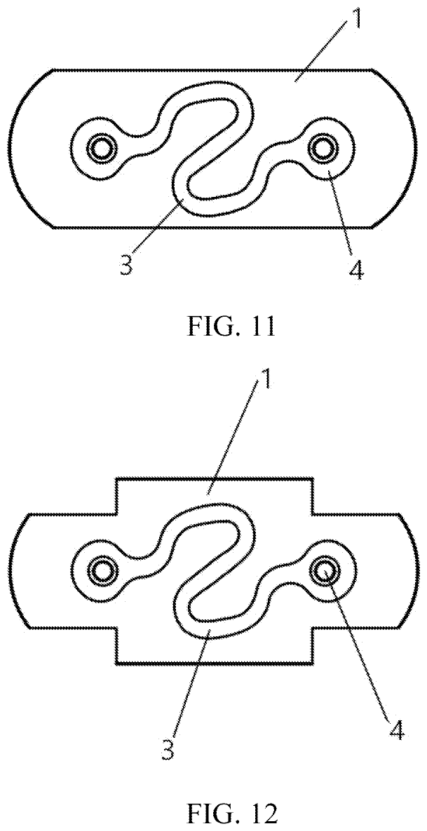

Referring to FIG. 1 to FIG. 12, an embodiment of the present disclosure provides an electronic cigarette atomization core 100, applied to an electronic cigarette. The electronic cigarette atomization core 100 includes:
a porous body 1 and a heating body 3, where the porous body 1 includes a liquid absorbing end and an atomization end, the atomization end includes an end surface facing away from the liquid absorbing end, and e-liquid in the electronic cigarette may penetrate into the atomization end through the liquid absorbing end. The heating body 3 is arranged on the end surface. That is, the heating body 3 is arranged on one end of the porous body 1 facing away from the liquid absorbing end, so that an atomization surface is formed on the atomization end.

The atomization surface includes a first atomization region, the first atomization region is located on the end surface, the first atomization region is a region in which a temperature can reach a predetermined atomization temperature range by means of heating of the heating body 3, that is, the e-liquid flowing to the first atomization region may be effectively atomized, and a ratio of an area of the first atomization region to an area of the end surface ranges from 0.05 to 0.90. When the e-liquid of the electronic cigarette flows to the end surface, the heating body 3 may atomize the e-liquid in the first atomization region in a case of generating heat, to provide vapor inhalable by a user.

In some embodiments, the heating body 3 is arranged on the end surface of the porous body 1 facing away from the liquid absorbing end, and when the area of the end surface is too large, an area occupied by the heating body 3 on the end surface is too small. As a result, the ratio of the area of the first atomization region to the area of the end surface is too small, and the area of the end surface cannot be effectively used to atomize the e-liquid. When the area of the end surface is too large, a space occupied by the end surface in the electronic cigarette is increased, and the atomization efficiency of the electronic cigarette atomization core 100 is reduced. When the area of the end surface is too small, although the heating body 3 may occupy a large area on the end surface, to cause the ratio of the area of the first atomization region to the area of the end surface to be large, a component such as a patch board further needs to be arranged on the end surface to implement electrical connection of the heating body. As a result, a full atomization effect of the end surface cannot be achieved. Therefore, in the present disclosure, by controlling the ratio of the area of the first atomization region to the area of the end surface to range from 0.05 to 0.90, the atomization efficiency of the electronic cigarette atomization core 100 may be improved while arrangement of the heating body 3 and an electrical connection component thereof is ensured.

In some embodiments, the heating body 3 may bend in a circumferential direction of the porous body 1 to form at least one protruding section and/or at least one recessed section, and an edge of at least one section of the end surface matches a contour of the heating body 3. For example, the edge of the at least one section of the end surface is equally spaced apart from an edge of the contour of the heating body 3, or an entire edge of the end surface matches the entire contour of the heating body 3.

In some embodiments, the end surface may encircle an effective heating region of the heating body 3, so that an atomization surface may be formed on both the end surface and a side surface of the porous body 1 when the heating body 3 generates heat. The atomization surface is a region in which a temperature reaches an atomization temperature when the heating body 3 generates heat, for example, a region in which a temperature reaches 150° C., 180° C., or higher. The heating body 3 is arranged on the end surface, so that the heating body 3 may directly heat the end surface when the heating body performs heating, namely, form the first atomization region. The e-liquid in the first atomization region may be atomized after being heated, so that the heating efficiency of the heating body 3 and an atomization effect of the electronic cigarette atomization core 100 are improved.

The electronic cigarette atomization core 100 provided in this embodiment of the present disclosure includes a porous body 1 and a heating body 3, where an atomization end of the porous body 1 includes an end surface facing away from a liquid absorbing end. The heating body 3 is arranged on the end surface, so that an atomization surface is formed on the atomization end. The atomization surface includes a first atomization region, the first atomization region is located on the end surface, and a ratio of an area of the first atomization region to an area of the end surface ranges from 0.05 to 0.90. The first atomization region is a region in which a temperature can reach a predetermined atomization temperature range by means of heating of the heating body 3. That is, e-liquid flowing to the first atomization region may be effectively atomized, so that the atomization efficiency of the electronic cigarette atomization core 100 is improved while flexible arrangement of the heating body 3 is ensured.

Optionally, the ratio of the area of the first atomization region to the area of the end surface ranges from 0.25 to 0.75, and preferably, ranges from 0.40 to 0.60.

In some embodiments, the first atomization region is a region in which a temperature can reach the predetermined atomization temperature range by means of heating of the heating body 3. The first atomization region is located on the end surface, to fully utilize the area of the end surface, at least one protruding section and/or at least one recessed section may be formed through the bent heating body 3, where the protruding section may heat and atomize an edge of the end surface and even a side surface of the porous body 1, and in the recessed section, a middle portion of the end surface may be atomized. In this way, the ratio of the area of the first atomization region to the area of the end surface is increased. For example, when the area of the end surface is 20 mm², through heating of the heating body 3, an area of a first atomization region whose predetermined atomization temperature is 180° C. or higher may reach 4.8 mm² or larger, and an area of a first atomization region whose predetermined atomization temperature is 200° C. or higher may reach 3 mm² or larger.

Optionally, the predetermined atomization temperature range is from 150° C. to 300° C., and preferably, is from 180° C. to 240° C.

In some embodiments, the e-liquid in the electronic cigarette may penetrate into the end surface through the liquid absorbing end of the porous body 1, and in a case that the heating body 3 generates heat, a temperature of the first atomization region may reach the predetermined atomization temperature, and the e-liquid in the first atomization region may be atomized. Main components of the e-liquid of the electronic cigarette include propylene glycol, vegetable glycerin, pure water, and fragrance, in a case that the predetermined atomization temperature range is from 150° C. to 300° C., it may be ensured that the e-liquid in the first atomization region can be partially or all atomized, thereby ensuring the atomization efficiency of the electronic cigarette atomization core 100.

Optionally, the atomization surface includes a second atomization region, the second atomization region is a region in which a temperature can reach the predetermined atomization temperature range by means of heating of the heating body 3, the second atomization region is at least a part of a side surface of the atomization end, and the side surface is adjacent to the end surface.

In some embodiments, when an extending track of the heating body 3 is close to an edge of at least one section of the end surface, heat radiated by heating of the heating body 3 may be transferred to at least a part of a side surface of the porous body 1, so that a temperature of the at least a part of the side surface of the porous body 1 reaches the predetermined atomization temperature range, that is, the second atomization region is formed on the at least a part of the side surface of the porous body 1. Through cooperation of the second atomization region and the first atomization region, an area of the atomization surface is increased, an atomization amount of the electronic cigarette atomization core 100 is improved, and an atomization effect of the electronic cigarette atomization core 100 is further ensured.

Optionally, a ratio of an area of the second atomization region to an area of the side surface ranges from 0.05 to 0.90, preferably, ranges from 0.25 to 0.75, and more preferably, ranges from 0.40 to 0.60.

In some embodiments, the second atomization region is a region in which a temperature can reach the predetermined atomization temperature range by means of heating of the heating body 3. The second atomization region is located on the side surface of the porous body 1, to fully utilize the area of the side surface, a heating temperature of the heating body 3 needs to be continuously improved. For example, when the ratio of the area of the second atomization region to the area of the side surface is too large, the heating temperature of the heating body 3 also needs to be too high. As a result, on one hand, excessive energy may be consumed, and a large energy loss is generated; and on the other hand, the e-liquid may be carbonized due to the excessively high temperature of the heating body 3, a black carbon layer is formed on a surface of the heating body 3, and the atomization efficiency and a service life of the electronic cigarette atomization core 100 are reduced. When the ratio of the area of the second atomization region to the area of the side surface is too small, although the heating temperature of the heating body 3 does not need to be strictly required, a decrease in the area of the second atomization region also reduces the atomization efficiency of the electronic cigarette atomization core 100.

Optionally, the electronic cigarette atomization core 100 further includes a patch board 4. The patch board 4 is connected to two ends of the heating body 3.

A ratio of an area of the patch board 4 to the area of the end surface ranges from 0.02 to 0.25, and preferably, ranges from 0.15 to 0.2.

In some implementations, referring to FIG. 1 to FIG. 12, the patch board 4 is arranged on the end surface, an electrode is arranged on the patch board 4, and the electrode is configured to be electrically connected to an external power supply. An end portion of the patch board 4 may be set to an arc shape, so that the ratio of the area of the patch board 4 to the area of the end surface is controlled to range from 0.02 to 0.25. In this way, excessive occupation of the area of the patch board 4 on the area of the end surface is avoided, absorption of heat of the heating body 3 by the patch board 4 is reduced, and the atomization efficiency of the heating body 3 is improved.

In some embodiments, the electrode on the patch board 4 may include a positive electrode and a negative electrode. When the heating body 3 is applied to an electronic cigarette, a voltage is applied to the positive electrode and the negative electrode by a power supply in the electronic cigarette, so that the heating body 3 may be powered. The heating body 3 may convert electric energy into heat energy when powered, and the e-liquid at the atomization end of the electronic cigarette atomization core 100 may be atomized when the heating body 3 generates heat, thereby ensuring an atomization effect of the electronic cigarette.

Optionally, referring to FIG. 1 to FIG. 4, the heating body 3 is arranged on the end surface in a shape of a square wave.

In some embodiments, referring to FIG. 1, the heating body 3 in a shape of a square wave may include one first bending section and one second bending section, where bending directions of the first bending section and the second bending section are reverse. The two ends of the heating body 3 are a first connection section and a second connection section, respectively. The heating body 3 further includes a first heating section, a second heating section, and a third heating section, where the first heating section is connected between the first connection section and the first bending section, the second heating section is connected to the first bending section and the second bending section, respectively, and the third heating section is connected between the second bending section and the second connection section. The first bending section and the second bending section may each form a protruding section, and the first heating section, the second heating section, and the third heating section may each form a recessed section. The first connection section and the second connection section respectively extend to two ends of the first atomization region, and the first heating section, the second heating section, the third heating section, the first bending section, and the second bending section may provide a main heat source to the heating body 3, so that the atomization surface is heated in a balanced manner.

Optionally, the end surface is in a shape of an ellipse, the heating body 3 is arranged in a length direction of the end surface, a first interval is formed between an edge of one end of the end surface and a corresponding end portion of the heating body 3, and a second interval is formed between an edge of a side of the end surface and a corresponding side of the heating body 3.

The first interval ranges from 0.05 mm to 4.0 mm, and the second interval ranges from 0.05 mm to 4.0 mm.

In some embodiments, in the electronic cigarette atomization core 100, through heating of the heating body 3, the atomization surface is formed on the atomization end of the porous body. To ensure that the heating efficiency of the heating body 3 is improved in a case that the heating body 3 has a low arrangement length, the heating body 3 may be bent in a circumferential direction of the porous body 1 to form at least one protruding section and/or at least one recessed section, to cause an entire contour of the heating body 3 to be in a shape of an ellipse. When the end surface of the porous body 1 matches the entire contour of the heating body 3, the end surface may be set to a shape of an ellipse. When the heating body 3 is arranged in the length direction of the end surface, the first interval is formed between the edge of one end of the end surface and the corresponding end portion of the heating body 3, and the second interval is formed between the edge of the side of the end surface and the corresponding side of the heating body 3. When the first interval and the second interval are both controlled to range from 0.05 mm to 4.0 mm, through heating of the heating body 3, at least a part in the first interval and at least a part in the second interval reach the predetermined atomization temperature range, so that the structure arrangement of the heating body 3 is simplified and the heating efficiency of the heating body 3 is improved.

Optionally, the first interval ranges from 0.05 mm to 2.0 mm, and/or the second interval ranges from 0.05 mm to 2.0 mm.

In some embodiments, when ranges of the first interval and the second interval are large, a large area of the end surface may be occupied, and the atomization utilization of the end surface is reduced when space of the first interval and the second interval is not effectively used. When segmentation is performed on the end surface or a size of a shaping mold is reduced to cause the ranges of the first interval and the second interval to be from 0.05 mm to 2.0 mm, to improve a matching degree between the end surface and the heating body 3, the ratio of the area of the first atomization region to the area of the end surface is improved.

In a specific embodiment, referring to FIG. 1 to FIG. 3, in FIG. 1, a first interval is formed between an edge of a left end of the end surface and a left end portion of the heating body 3, and a first interval is formed between an edge of a right end of the end surface and a right end portion of the heating body 3; and a second interval is formed between an edge of an upper side of the end surface and an upper side of the heating body 3, and a second interval is formed between an edge of a lower side of the end surface and a lower side of the heating body 3.

The first interval in FIG. 1 is large and cannot be fully utilized during heating of the heating body 3, so that the left and right ends of the end surface may be segmented as changes from FIG. 1 to FIG. 2, to reduce a size of the first interval and improve the atomization utilization of the end surface within a range of the first interval. In addition, the second interval in FIG. 1 is large and cannot be fully utilized during heating of the heating body 3, so that the upper and lower sides of the end surface may be segmented as changes from FIG. 1 to FIG. 3, to reduce a size of the second interval and improve the atomization utilization of the end surface within a range of the second interval.

Optionally, at least one section of an edge of the end surface is in a shape of a step.

In some embodiments, sizes of the first interval and the second interval are great, to improve the atomization utilization of the end surface within the range of the first interval and the end surface within the range of the second interval simultaneously, positions at which the first interval and the second interval are connected on the end surface may be segmented as changes from FIG. 1 to FIG. 4. When a size of an upper-left corner and a size of a lower-right corner of the end surface are reduced, the atomization utilization of the end surface may be significantly improved.

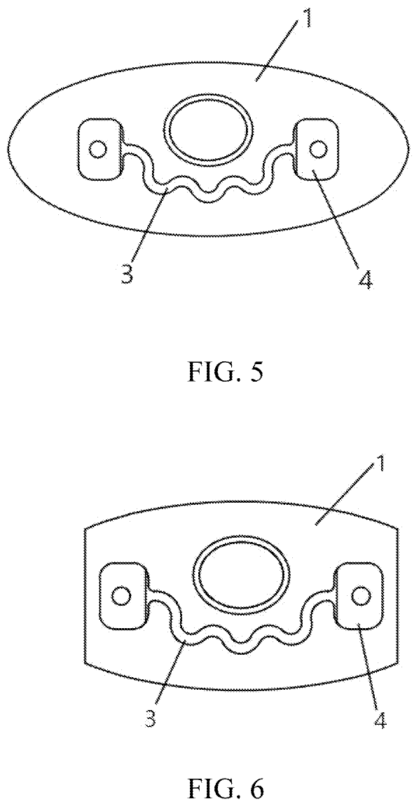

Optionally, referring to FIG. 5 to FIG. 8, the heating body 3 is arranged on the end surface in a shape of a wave.

In some embodiments, when the heating body 3 is in a shape of a wave, the heating body 3 may be bent to form a plurality of protruding sections and a plurality of recessed sections, and as shown in FIG. 5, the heating body 3 in a shape of a wave may be close to an edge of one side of the end surface. By arranging the heating body 3 in a shape of a wave, the heating efficiency of the heating body 3 may be improved, the atomization surface may be heated in a balanced manner, and the ratio of the area of the first atomization region to the area of the end surface may be improved.

Optionally, the end surface is in a shape of an ellipse, and the heating body 3 is arranged in a length direction of the end surface.

In some embodiments, referring to FIG. 5, when the end surface is arranged in a shape of an ellipse and the heating body 3 is arranged in the length direction of the end surface, a first interval is formed between an edge of a left end of the end surface and a left end portion of the heating body 3, and a first interval is formed between an edge of a right end of the end surface and a right end portion of the heating body 3; and a second interval is formed between an edge of a lower side of the end surface and a lower side of the heating body 3. The first interval in FIG. 5 is large and cannot be fully utilized during heating of the heating body 3, so that the left and right ends of the end surface may be segmented as changes from FIG. 5 to FIG. 6, to reduce a size of the first interval and improve the atomization utilization of the end surface within a range of the first interval. In addition, the second interval in FIG. 5 is large and cannot be fully utilized during heating of the heating body 3, so that the upper and lower sides of the end surface may be segmented as changes from FIG. 5 to FIG. 7, to reduce a size of the second interval and improve the atomization utilization of the end surface within a range of the second interval.

Optionally, referring to FIG. 8, the end surface includes a first end surface and a second end surface that are perpendicular to each other, a length of the first end surface is greater than a length of the second end surface, and the heating body 3 is arranged in a length direction of the first end surface.

In some embodiments, through arrangement of the first end surface and the second end surface, the end surface is cross-shaped, and since the length of the first end surface is greater than the length of the second end surface, when the heating body 3 is arranged in the length direction of the first end surface, the ratio of the area of the first atomization region to the area of the end surface may be improved while the heating efficiency of the heating body 3 is ensured. From comparison between FIG. 8 and FIG. 5, sizes of the first interval and the second interval are great, to improve the atomization utilization of the end surface within the range of the first interval and the end surface within the range of the second interval simultaneously, positions at which the first interval and the second interval are connected on the end surface may be segmented, and specifically, four corners of the end surface are segmented, to improve the atomization utilization of the end surface.

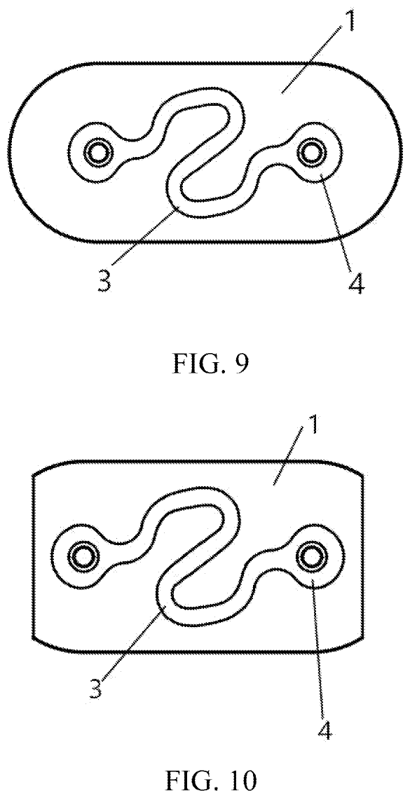

Optionally, referring to FIG. 9 to FIG. 12, the heating body 3 is arranged on the end surface in a shape of zigzag.

In some embodiments, referring to FIG. 9, the heating body 3 in a shape of zigzag may include a first bending section and a second bending section, where bending directions of the first bending section and the second bending section are reverse, and two ends of the heating body 3 are respectively a first connection section and a second connection section. The heating body 3 further includes a first heating section, where the first heating section is connected between the first bending section and the second bending section. The first bending section and the second bending section each form a protruding section, and the first heating section forms a recessed section. The first connection section and the second connection section respectively extend to two ends of the first atomization region, and the first heating section, the first bending section, and the second bending section provide a main heat source to the heating body 3, so that the atomization surface may be heated in a balanced manner.

Optionally, the end surface is in a shape of an ellipse, and the heating body 3 is arranged in a length direction of the end surface.

In some embodiments, referring to FIG. 9, when the end surface is arranged in a shape of an ellipse and the heating body 3 is arranged in the length direction of the end surface, a first interval is formed between an edge of a left end of the end surface and a left end portion of the heating body 3, and a first interval is also formed between an edge of a right end of the end surface and a right end portion of the heating body 3; and a second interval is formed between an edge of an upper side of the end surface and an upper side of the heating body 3, and a second interval is formed between an edge of a lower side of the end surface and a lower side of the heating body 3. The first interval in FIG. 9 is large and cannot be fully utilized during heating of the heating body 3, so that the left and right ends of the end surface may be segmented as changes from FIG. 9 to FIG. 10, to reduce a size of the first interval and improve the atomization utilization of the end surface within a range of the first interval. In addition, the second interval in FIG. 9 is large and cannot be fully utilized during heating of the heating body 3, so that the upper and lower sides of the end surface may be segmented as changes from FIG. 9 to FIG. 11, to reduce a size of the second interval and improve the atomization utilization of the end surface within a range of the second interval.

Optionally, referring to FIG. 12, the end surface includes a first end surface and a second end surface that are perpendicular to each other, a length of the first end surface is greater than a length of the second end surface, and the heating body 3 is arranged in a length direction of the first end surface.

In some embodiments, through arrangement of the first end surface and the second end surface, the end surface is cross-shaped, and since the length of the first end surface is greater than the length of the second end surface, when the heating body 3 is arranged in the length direction of the first end surface, the ratio of the area of the first atomization region to the area of the end surface may be improved while the heating efficiency of the heating body 3 is ensured. From comparison between FIG. 12 and FIG. 9, sizes of the first interval and the second interval are great, to improve the atomization utilization of the end surface within the range of the first interval and the end surface within the range of the second interval simultaneously, positions at which the first interval and the second interval are connected on the end surface may be segmented, and specifically, four corners of the end surface are segmented, to improve the atomization utilization of the end surface.

The present disclosure further provides an electronic cigarette, and the electronic cigarette includes the electronic cigarette atomization core 100 of the present disclosure.

In some embodiments, the electronic cigarette atomization core 100 of the electronic cigarette includes a porous body 1 and a heating body 3, where an atomization end of the porous body 1 includes an end surface facing away from a liquid absorbing end. The heating body 3 is arranged on the end surface, so that an atomization surface is formed on the atomization end. The atomization surface includes a first atomization region, the first atomization region is located on the end surface, and a ratio of an area of the first atomization region to an area of the end surface ranges from 0.05 to 0.90. The first atomization region is a region in which a temperature can reach a predetermined atomization temperature range by means of heating of the heating body 3. That is, e-liquid flowing to the first atomization region may be effectively atomized, so that the atomization efficiency of the electronic cigarette is improved while flexible arrangement of the heating body 3 is ensured.

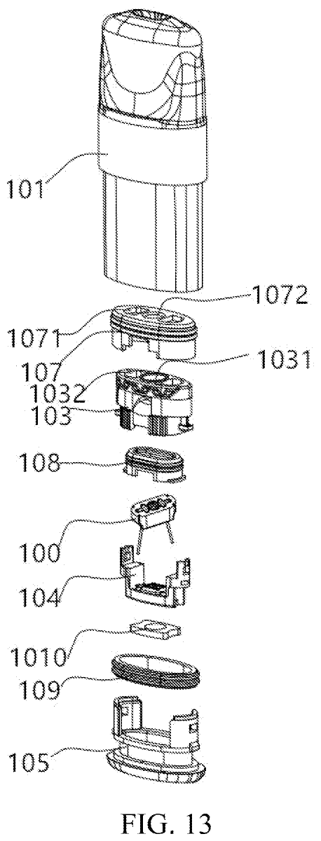

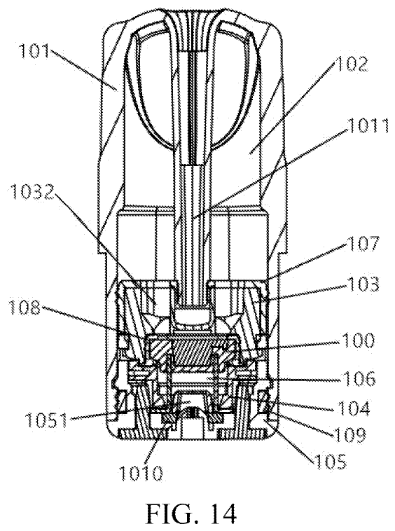

Optionally, referring to FIG. 13 and FIG. 14, the electronic cigarette further includes a housing 101, a liquid storage cavity 102 arranged in the housing 101, and a first seal element 108, where the first seal element 108 is sleeved on the porous body 1, and the first seal element 108 at least covers a part of an outer peripheral surface of the porous body 1 and an edge of the liquid absorbing end.

In some embodiments, when the first seal element 108 is sleeved on the porous body 1, that is, when the first seal element 108 is sleeved on a periphery of the atomization core 100, e-liquid on a liquid absorbing surface may be effectively sealed, and leakage of the e-liquid may be prevented.

Optionally, referring to FIG. 13 and FIG. 14, the electronic cigarette further includes:
an upper support 103, a lower support 104, and a lower cover 105, where the lower cover 105 covers the opening end of the housing 101; the lower cover 105 has an air inlet hole 1051;
the upper support 103 cooperates with the lower support 104 to form an accommodating cavity, and the electronic cigarette atomization core 100 is arranged in the accommodating cavity; and
the upper support 103 has a liquid guide hole 1032, and the liquid absorbing end of the porous body 1 is in communication with the liquid storage cavity 102 through the liquid guide hole 1032; and an atomization chamber 106 is formed between the atomization surface and the lower support 104, and the lower support 104 has a vent hole in communication with the air inlet hole 1051.

In some embodiments, during operation of an electronic cigarette atomization assembly, e-liquid flowing out of the liquid storage cavity 102 is guided to the liquid absorbing end of the porous body 1 through the liquid guide hole 1032, and is absorbed to the heating body 3 on the atomization end of the porous body 1 through a capillary action of the porous body 1, to form vapor after being heated and atomized by the heating body 3. In this case, under an action of inhalation by a user at the air outlet channel 1011, air in the air inlet hole 1051 is driven to enter the atomization chamber 106, and the air carries aerosols in the atomization chamber 106 to the air outlet channel 1011. Since the e-liquid is continuously absorbed and supplemented by the porous body 1 to the heating body 3, a negative pressure is formed in the liquid storage cavity 102, and under an action of the negative pressure, external air may enter the liquid guide hole 1032 and the liquid storage cavity 102 through the atomization chamber 106 and the electronic cigarette atomization core 100, to form air pressure balance, thereby ensuring that the e-liquid may be guided into the porous body 1 smoothly.

Optionally, referring to FIG. 13 and FIG. 14, the electronic cigarette further includes a second seal element 107 and a third seal element 109.

The second seal element 107 is sleeved on a periphery of the upper support 103, an outer edge of the second seal element 107 abuts against an inner wall of the housing 101 to encircle and form the liquid storage cavity 102, the second seal element 107 has a first communication hole 1071 communicating the liquid storage cavity 102 with the liquid guide hole 1032, and the second seal element 107 has a second communication hole 1072 communicating the air outlet channel 1011 with the air outlet hole 1031.

The first seal element 108 is sleeved on a periphery of the electronic cigarette atomization core 100. The third seal element 109 is arranged surrounding a periphery of the lower cover 105, and an outer edge of the third seal element 109 abuts against the inner wall of the housing 101.

In some embodiments, the second seal element 107, the first seal element 108, and the third seal element 109 are configured to provide necessary sealing inside the electronic cigarette, to prevent unnecessary communication between the liquid storage cavity 102 and a connection gap of each element, so that liquid leakage is effectively prevented. In addition, the electronic cigarette further includes a liquid absorbing element 1010, where the liquid absorbing element 1010 is arranged surrounding a periphery of the air inlet hole 1051, and the liquid absorbing element 1010 is configured to absorb condensate flowing out of the air inlet hole 1051.

According to the embodiments of the present disclosure, the electronic cigarette may not include the lower support. That is, the upper support 103 directly cooperates with and is connected to the lower cover 105 to form an accommodating cavity, the electronic cigarette atomization core 100 is located in the accommodating cavity, and cooperation and connection between the upper support 103 and the lower cover 105 may be formed in a clamping manner. A specific description is provided with reference to FIG. 13 and FIG. 14. The electronic cigarette includes the electronic cigarette atomization core 100 described above, a housing 101, a liquid storage cavity 102 arranged in the housing 101, a first seal element 108, and a lower cover 105.

The housing 101 includes an opening end, the housing 101 is provided with an air outlet channel 1011, the lower cover 105 covers the opening end of the housing 101, the lower cover 105 has an air inlet hole 1051, the first seal element 108 is sleeved on the porous body 1, and the first seal element 108 at least covers a part of an outer peripheral surface of the porous body 1 and an edge of the liquid absorbing end.

In this embodiment, the electronic cigarette further includes an upper support 103 and a second seal element 107, the upper support 103 cooperates with and is connected to the lower cover 105 to form a cavity, and the electronic cigarette atomization core 100 is located in the cavity. The upper support 103 has a liquid guide hole 1032, and the liquid absorbing end of the porous body 1 is in communication with the liquid storage cavity 102 through the liquid guide hole 1032. The second seal element 107 is sleeved on a periphery of the upper support 103, an outer edge of the second seal element 107 abuts against an inner wall of the housing 101 to encircle and form the liquid storage cavity 102, the second seal element 107 has a first communication hole 1071 communicating the liquid storage cavity 102 with the liquid guide hole 1032, and the second seal element 107 has a second communication hole 1072 communicating the air outlet channel 1011 with the atomization chamber 106. In this embodiment, the electronic cigarette may not include the lower support 104, and the upper support 103 cooperates with the lower cover 105 to fix the electronic cigarette atomization core 100.

Optionally, the electronic cigarette includes:
a shell, a liquid storage cavity located in the shell;
a lower base, where the lower base cooperates with the shell to form an accommodating cavity, and the lower base is provided with an air inlet channel; and
a fourth seal element, where the fourth seal element is located in the accommodating cavity, the fourth seal element is sleeved on the porous body 1 of the electronic cigarette atomization core 100, and the fourth seal element is in interference fit with the shell and the porous body 1.

In some embodiments, a structure of the electronic cigarette atomization assembly is simple, less space is occupied by structures in the shell, and a volume of a space for forming an atomization cavity in the electronic cigarette is increased. Compared with the related art, the electronic cigarette atomization assembly in this solution only uses a form that the shell cooperates with the lower base to limit structures such as the atomization core, so that the structure in the electronic cigarette atomization assembly is simplified, and more space are left for the atomization core and the atomization cavity. In such an electronic cigarette atomization assembly, the volume of the atomization cavity can be larger compared with the related art, so that effective use time of the electronic cigarette is improved. That is, the electronic cigarette in the present disclosure may not include the upper support 103 and the lower support 104. Since the first seal element 108 is sleeved on the porous body 1 and is in interference fit with both the inner wall of the housing 101 and the porous body, the electronic cigarette atomization core 100 is fixed through an interference fit between the first seal element 108 with the inner wall of the housing 101. This embodiment is specifically described with reference to FIG. 13 and FIG. 14, the electronic cigarette includes the electronic cigarette atomization core 100, a housing 101, a liquid storage cavity 102 arranged in the housing 101, a first seal element 108, and a lower cover 105. The housing 101 includes an opening end, the housing 101 is provided with an air outlet channel 1011, the lower cover 105 covers the opening end of the housing 101 to form a chamber, the lower cover 105 has an air inlet hole 1051, the first seal element 108 is sleeved on the porous body 1, the first seal element 108 at least covers a part of an outer peripheral surface of the porous body 1 and an edge of the liquid absorbing end, the first seal element 108 abuts against the inner wall of the housing, the electronic cigarette atomization core 100 is arranged in the chamber, a space between the atomization end of the porous body 1 and the lower cover 105 forms an atomization chamber 106, and the atomization chamber 106 is in communication with the air outlet channel 1011 and the air inlet hole 1051, respectively.

In the electronic cigarette according to the present disclosure, a conductive nail runs through the lower cover 105, and the conductive nail is electrically connected to the heating body 3.

Although some specific embodiments of the present disclosure have been described in detail through examples, a person skilled in the art should understand that the foregoing examples are merely used for description rather than limiting the scope of the present disclosure. A person skilled in the art should understand that, modifications may be made to the foregoing embodiments without departing from the scope and the spirit of the present disclosure. The scope of the present disclosure is limited by the appended claims.

What is claimed is:

1. An electronic cigarette atomization core (100), comprising:
a porous body (1) comprising a liquid absorbing end and an atomization end, wherein the atomization end comprising an end surface facing away from the liquid absorbing end; and
a heating body (3) being arranged on the end surface to form an atomization surface on the atomization end,
wherein the atomization surface comprises a first atomization region, the first atomization region being located on the end surface, the first atomization region being a region in which a temperature can reach a predetermined atomization temperature range by means of heating of the heating body (3), and a ratio of an area of the first atomization region to an area of the end surface ranging from 0.05 to 0.90.

2. The electronic cigarette atomization core (100) according to claim 1, wherein the ratio of the area of the first atomization region to the area of the end surface ranges from 0.25 to 0.75.

3. The electronic cigarette atomization core (100) according to claim 1, wherein the predetermined atomization temperature range is from 150° C. to 300° C.

4. The electronic cigarette atomization core (100) according to claim 1, wherein the atomization surface comprises a second atomization region, the second atomization region being a region in which a temperature can reach the predetermined atomization temperature range by means of heating of the heating body (3), the second atomization region comprising at least a part of a side surface of the atomization end, and the side surface being adjacent to the end surface.

5. The electronic cigarette atomization core (100) according to claim 4, wherein a ratio of an area of the second atomization region to an area of the side surface ranges from 0.05 to 0.90.

6. The electronic cigarette atomization core (100) according to claim 1, further comprising a patch board (4) being connected to two ends of the heating body (3),
wherein a ratio of an area of the patch board (4) to the area of the end surface ranges from 0.02 to 0.25.

7. The electronic cigarette atomization core (100) according to claim 1, wherein the heating body (3) is arranged on the end surface in a shape of a square wave.

8. The electronic cigarette atomization core (100) according to claim 7, wherein the end surface is in a shape of an ellipse, the heating body (3) is arranged in a length direction of the end surface, a first interval is formed between an edge of one end of the end surface and a corresponding end portion of the heating body (3), and a second interval is formed between an edge of a side of the end surface and a corresponding side of the heating body (3); and
the first interval ranges from 0.05 mm to 4.0 mm, and the second interval ranges from 0.05 mm to 4.0 mm.

9. The electronic cigarette atomization core (100) according to claim 8, wherein the first interval ranges from 0.05 mm to 2.0 mm, and/or the second interval ranges from 0.05 mm to 2.0 mm.

10. The electronic cigarette atomization core (100) according to claim 7, wherein at least one section of an edge of the end surface is in a shape of a step.

11. The electronic cigarette atomization core (100) according to claim 1, wherein the heating body (3) is arranged on the end surface in a shape of a wave.

12. The electronic cigarette atomization core (100) according to claim 11, wherein the end surface is in a shape of an ellipse, and the heating body (3) is arranged in a length direction of the end surface.

13. The electronic cigarette atomization core (100) according to claim 11, wherein the end surface comprises a first end surface and a second end surface, the first end surface and the second end surface being perpendicular to each other, a length of the first end surface being greater than a length of the second end surface, wherein the heating body (3) is arranged in a length direction of the first end surface.

14. The electronic cigarette atomization core (100) according to claim 1, wherein the heating body (3) is arranged on the end surface in a shape of zigzag.

15. The electronic cigarette atomization core (100) according to claim 14, wherein the end surface is in a shape of an ellipse, and the heating body (3) is arranged in a length direction of the end surface.

16. The electronic cigarette atomization core (100) according to claim 14, wherein the end surface comprises a first end surface and a second end surface, the first end surface and the second end surface being perpendicular to each other, a length of the first end surface being greater than a length of the second end surface, wherein the heating body (3) is arranged in a length direction of the first end surface.

17. An electronic cigarette, comprising the electronic cigarette atomization core (100) according to claim 1.

18. An electronic cigarette, comprising:
the electronic cigarette atomization core (100) according to claim 1; and
a housing (101), a liquid storage cavity (102) arranged in the housing (101), a first seal element (108), and a lower cover (105), the housing (101) comprising an opening end, the housing (101) being provided with an air outlet channel (1011), the lower cover (105) covering the opening end of the housing (101) to form a chamber, the lower cover (105) having an air inlet hole (1051), the first seal element (108) being sleeved on the porous body (1), the first seal element (108) at least covering a part of an outer peripheral surface of the porous body (1) and an edge of the liquid absorbing end, the first seal element (108) abutting against an inner wall of the housing,
wherein the electronic cigarette atomization core (100) is arranged in the chamber, a space between the atomization end of the porous body (1) and the lower cover (105) forms an atomization chamber (106), the atomization chamber (106) being in communication with the air outlet channel (1011) and the air inlet hole (1051), respectively.

19. An electronic cigarette, comprising:
the electronic cigarette atomization core (100) according to claim 1;
a housing (101), a liquid storage cavity (102) arranged in the housing (101), a first seal element (108), and a lower cover (105), the housing (101) comprising an opening end, the housing (101) being provided with an air outlet channel (1011), the lower cover (105) covering the opening end of the housing (101), the lower cover (105) having an air inlet hole (1051), the first seal element (108) being sleeved on the porous body (1), and the first seal element (108) at least covering a part of an outer peripheral surface of the porous body (1) and an edge of the liquid absorbing end; and
further comprising an upper support (103) and a second seal element (107), the upper support (103) cooperating with and being connected to the lower cover (105) to form a cavity, the electronic cigarette atomization core (100) being located in the cavity,
wherein the upper support (103) has a liquid guide hole (1032), and the liquid absorbing end of the porous body (1) is in communication with the liquid storage cavity (102) through the liquid guide hole (1032); and
wherein the second seal element (107) is sleeved on a periphery of the upper support (103), an outer edge of the second seal element (107) abuts against an inner wall of the housing (101) to encircle and form the liquid storage cavity (102), the second seal element (107) has a first communication hole (1071) communicating the liquid storage cavity (102) with the liquid guide hole (1032), and the second seal element (107) has a second communication hole (1072) communicating the air outlet channel (1011) with the atomization chamber (106).

20. An electronic cigarette, comprising:
the electronic cigarette atomization core (100) according to claim 1;
a housing (101), a liquid storage cavity (102) arranged in the housing (101), a first seal element (108), and a lower cover (105), the housing (101) comprising an opening end, the housing (101) being provided with an air outlet channel (1011), the lower cover (105) covering the opening end of the housing (101), the lower cover (105) having an air inlet hole (1051), the first seal element (108) being sleeved on a periphery of the electronic cigarette atomization core (100);
further comprising an upper support (103), a second seal element (107), and a lower support (104),
wherein the upper support (103) cooperates with the lower support (104) to form an accommodating cavity, the electronic cigarette atomization core (100) is arranged in the accommodating cavity;
wherein the upper support (103) has a liquid guide hole (1032), and the liquid absorbing end of the porous body (1) is in communication with the liquid storage cavity (102) through the liquid guide hole (1032), an atomization chamber (106) is formed between the atomization surface and the lower support (104), and the lower support (104) has a vent hole in communication with an air inlet hole (1051); and
wherein the second seal element (107) is sleeved on a periphery of the upper support (103), an outer edge of the second seal element (107) abuts against an inner wall of the housing (101) to encircle and form the liquid storage cavity (102), the second seal element (107) has a first communication hole (1071) communicating the liquid storage cavity (102) with the liquid guide hole (1032), and the second seal element (107) has a second communication hole (1072) communicating the air outlet channel (1011) with an air outlet hole (1031); and
further comprising a third seal element (109), the third seal element (109) being arranged surrounding a periphery of the lower cover (105), and an outer edge of the third seal element (109) abutting against the inner wall of the housing (101).
